(19) United States
(12) Patent Application Publication
(10) Pub. No.: US 2007/0162437 A1
(43) Pub. Date: Jul. 12, 2007

(54) User terminal and music file management method therefor

(75) Inventor: Jun-ho Hwang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/518,155

(22) Filed: Sep. 11, 2006

(30) Foreign Application Priority Data
Jan. 3, 2006 (KR) 10-2006-00716

(51) Int. Cl. G06F 17/30; G06F 7/00; G10H 7/00

(52) U.S. Cl. 707/4; 84/604

(57) ABSTRACT

An application program installed in a user terminal including a user interface unit for displaying a list of music files; a playback unit for playing back a music file selected out of the list; a transfer unit for transferring the selected music file to a certain storage medium; and a control unit for controlling the playback unit to play back the selected music file. The list being controlled at the same time to display an operation menu below music information of the music file being played back, if a playback request signal is input through the user interface unit, and controlling the transfer unit to transfer the selected music file, if a transfer request signal is input.

### CROSS-REFERENCE TO RELATED APPLICATIONS

This application claims priority from Korean Patent Application No. 10-2006-716 filed on Jan. 3, 2006, in the Korean Intellectual Property Office, the entire disclosure of which is incorporated herein by reference.

### BACKGROUND OF THE INVENTION

1. Field of the Invention

Apparatuses and methods consistent with the present invention relate to a user terminal and a music file management method therefore, and more particularly, to a user terminal and a music file management method therefor, which display information on music files through one user interface.

2. Description of the Related Art

With the advancements of multimedia contents and technologies related thereto, it is a recent trend that more users use music files created by use of audio data compression technologies such as MP3 (MPEG-1 Audio Layer 3).

When a user plays back music files using a user terminal such as a personal computer (PC), the user uses a multimedia playback program. Such multimedia playback programs are provided in a variety of forms by providers, such as the general forms illustrated in FIGS. 1 and 2.

FIG. 1 is a view for showing an example of a conventional multimedia playback program, and FIG. 2 is a view for showing an example of another conventional multimedia playback program.

In FIG. 1, a user interface (UI) 10 provided by a conventional multimedia playback program contains various kinds of menus for interfacing between a user and the multimedia playback program.

In addition, the UI 10 has a control area 12 for selecting functions such as playback, fast forward, or rewind, an information display area 15 for displaying a playback status, and a list display area 16 for displaying a list of plural music files.

A user can select a music file to playback through the UI 10, and control the selected music file to be played back. That is, the user selects a music file to be played back on the list display area 16 of the UI 10, and clicks on a playback button in the control area 12. By doing so, the multimedia playback program plays back the corresponding music file, and the title of the music and a playback progress status are displayed in the information display area 14.

Generally, a user selects a music file on the list display area 16 and clicks on the playback button on the control area 12 by using a mouse. In this arrangement, displacement of the mouse around the list display area 16 and the control area 12 is increased.

Further, if a user requests detailed information on a music file, the UI 10 shown in FIG. 1 provides the detailed information on the corresponding music file through a separate pop-up window. Thus, the user cannot be provided with desired information through one UI 10.

Description will be made on a multimedia playback program capable of providing detailed information on music files through one UI 20 with reference to FIG. 2. The UI 20 has a control area 22, a lyric display area 24, a list display area 26, and a detailed information display area 28.

Since the control area 22, lyric display area 24, list display area 26, and detailed information display area 28 are displayed in one window of the UI 20, a user can be provided with desired information through one window.

However, even in the UI 20 shown in FIG. 2, a user can play back a music file only if he or she selects the music file for playback on the list display area 26, moves into the control area 22, and clicks on the playback button. Therefore, there still exists a problem caused by the required movement to access the various areas.

### SUMMARY OF THE INVENTION

The present invention has been developed in order to address the above drawbacks and other issues associated with the conventional arrangement. An aspect of an exemplary embodiment of the present invention is to provide a user terminal and a music file management method therefore, capable of displaying playback, transfer, and related information on a window providing a list of music files.

The foregoing and other aspects of exemplary embodiments of the invention are substantially realized by providing a user terminal installed with an application program for music file playback, the application program comprising a user interface unit for displaying a list of music files; a playback unit for playing back a music file selected out of the list; a transfer unit for transferring the music file selected out of the list to a certain storage medium; and a control unit for controlling the playback unit to play back the selected music file at the same time of controlling the list to display an operation menu below music information of the music file being played back in the list, if a playback request signal is input through the user interface unit, and controlling the transfer unit to transfer the selected music file, if a transfer request signal is input.

The music information can include a song title, a singer name, an album title, genre, playback time, and preference.

The user interface unit can extend a line to expand an area displaying the music information of the selected music file to display the operation menu in the expanded portion.

Further, the operation menu is provided with buttons enabling a user to select functions of rewind, fast forward, volume control, detailed view, and lyrics view.

If the detailed view and lyrics view functions are selected, the user interface unit further can extend a line to expand an area displaying the music information and displays detailed information and lyrics information in the expanded portion.

The user interface unit can display a playback progress ratio of the playback unit in a bar on a line displaying music information of the selected music file.

The certain storage medium can be any of a specified folder, a Compact Disk (CD), and an MP3 player.

If a cursor is placed on a line displaying music information of the music file, the user interface unit can display a storage medium selection menu for transferring the music file by the transfer unit at a point where the cursor is located.

If the selected music file is completely played back, the control unit can control the playback unit to play back a music file next to the played-back music file on the list.

According to an exemplary embodiment of the present invention a music file management method is provided which comprises displaying a list of music files; and playing back, if a playback request signal is input for a music file selected by a user, the selected music file together with the list displaying an operation menu below music information of the music file being played, and transferring the selected music file to a certain storage medium if a transfer request signal is input.

When the operation menu is displayed, a line displaying music information of the selected music file can be extended, and the operation menu is displayed in the extended portion.

Further, preferably, the operation menu can be provided with buttons for selecting functions of rewind, fast forward, volume control, detailed view, and lyrics view.

If the user selects the functions of detailed view and lyrics view, a line displaying the music information can be further extended to display detailed information or lyrics information on the extended portion.

The certain storage medium can be any of a specified folder, a Compact Disk (CD), and an MP3 player.

The method can further comprise playing back a music file next to the played-back music file on the list after the selected music file is played back.

### BRIEF DESCRIPTION OF THE DRAWINGS

The above aspects and features of the present invention will be more apparent by describing certain embodiments of the present invention with reference to the accompanying drawings, in which:

FIG. 1 is a view for showing an example of a conventional multimedia playback program;

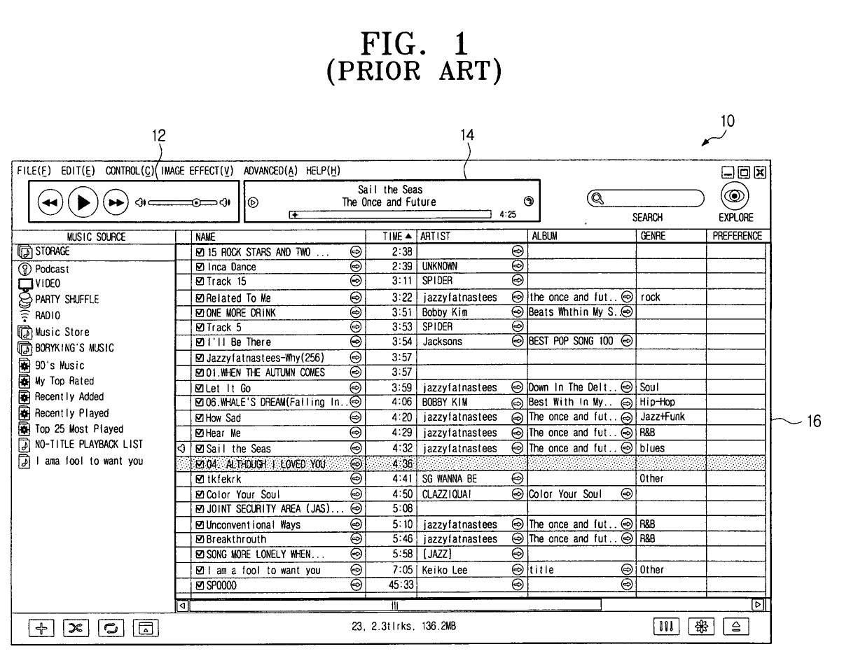

FIG. 2 is a view for showing an example of another conventional multimedia playback program;

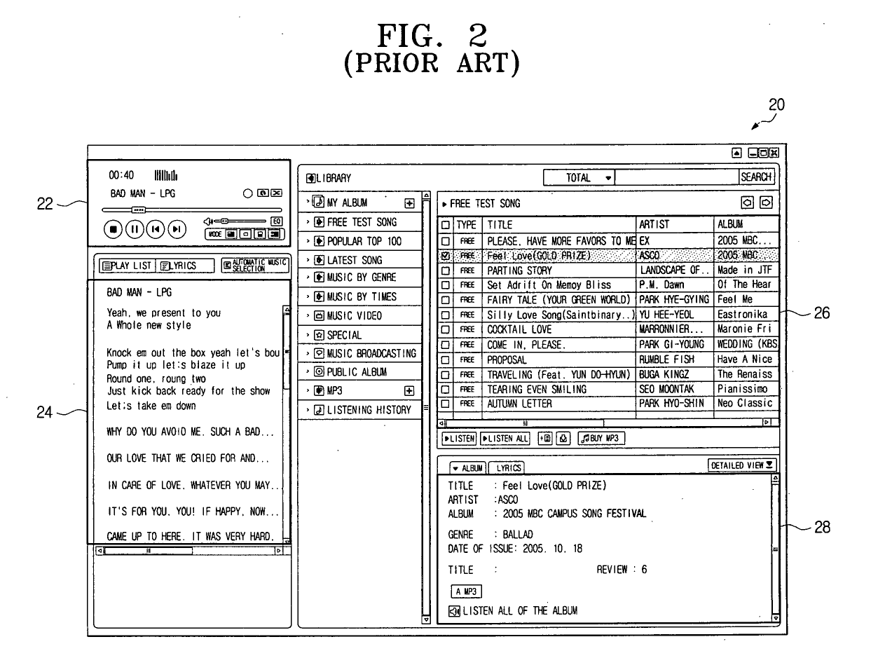

FIG. 3 is a block diagram for showing an application program according to an exemplary embodiment of the present invention;

FIG. 4 is a view for explaining functions of an application program according to an exemplary embodiment of the present invention;

FIGS. 5A to 5C are views for explaining a music file playback method using an application program according to an exemplary embodiment of the present invention; and

FIGS. 6A to 6B are views for explaining a music file transfer method using an application program according to an exemplary embodiment of the present invention.

### DETAILED DESCRIPTION OF THE PREFERRED EMBODIMENTS

Hereinafter, exemplary embodiments of the present invention will be described in detail with reference to the accompanying drawings.

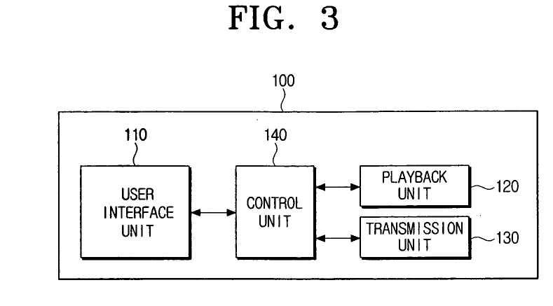

FIG. 3 is a block diagram for showing an application program according to an exemplary embodiment of the present invention.

A user terminal such as personal computer (PC) is installed with an application program 100 for playing back music files. The application program 100 for playing back music files can read plural music files stored in a certain storage medium, such a Hard Disk Drive (HDD) or a Compact Disk (CD), selected by a user. The music file can be, for example, an MP3 file.

In FIG. 3, the application program 100 installed in a user terminal according to an exemplary embodiment of the present invention includes a user interface unit 110, a playback module or unit 120, a transfer module or unit 130, and a control module or unit 140.

The user interface unit 110 performs interfacing between a user and the application program 100. The user interface unit 110 sends a certain request signal according to user's selection into the control module 140 which will be described below, and it can display a message intended to be sent to the user. The certain request signal input from a user includes, for example, a playback request signal, a transfer request signal, and a stop request signal.

The user interface unit 110 displays a list of plural music files under control of the control unit 140, and provides menus through which the user can input various request signals. The list displays music information on plural music files read from an HDD or CD. The music information can include song titles, singer names, album titles, genre, playback times, and preference, for example.

The user interface unit 110 displays an operation menu below the music information of a specific music file in the list of plural music files under control of the control unit 140. The user interface 110 extends the line displaying the music information on music files to display the operation menu in the expanded portion.

The operation menu displayed on the user interface unit 110 has buttons enabling a user to control the functions of the playback unit 120, which will be described later, such as a rewind, fast forward, pause, and volume control and buttons for receiving music file-related information such as detailed view and lyrics view.

If a user selects a detailed view or a lyrics view function, the user interface unit 110 further extends the line to expand the area displaying the music information to display detailed information or lyric information in the extended portion.

The user interface module 110 can display the playback progress ratio of the playback module 120 in the form of a bar on the line displaying the music information of the music file selected by a user to playback.

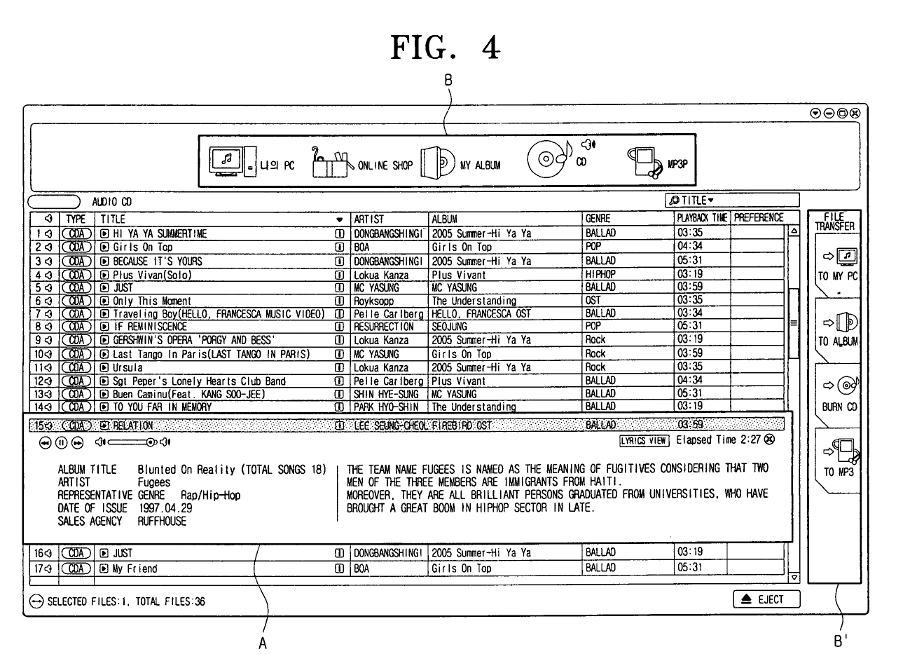

Further, if a cursor is placed on the line displaying the music information of a music file, the user interface unit 110 has a storage medium selection menu for transferring the music file through the transfer unit 130 which will be described below. The storage media includes a specified folder, a CD, and a MP3 player. Description will be made in detail on the user interface 110 with reference to FIG. 4 which will be explained later.

The playback unit 120 plays back a music file selected by a user out of the list of plural music files displayed through the user interface unit 110. If the user selects a specific music file to input a playback request signal, the playback unit 120 plays back the corresponding music file under control of the control unit 140.

In this exemplary embodiment, the list of plural music files displayed on the user interface unit 110 is provided with a playback button in front of the song title of each music file. Thus, if a user clicks on the playback button provided in front of the song title of a music file that the user desires to play back, a playback request signal is input.

The transfer unit 130 sends to a predetermined storage medium the music file selected by the user out of a list of plural music files displayed through the user interface unit 110. If the user selects a specific music file to input a transfer request signal, the transfer unit 130 sends the music file to a storage medium set by the user under control of the control unit 140. The storage medium can be a specified folder on an HDD, CD, or MP3 player.

The control unit 140 controls overall functions of the application program 100, which controls signal inputs and outputs between the user interface unit 110, playback unit 120, and transfer unit 130.

If a user inputs a playback request signal for a specific music file through the user interface unit 110, the control unit 140 controls the playback unit 120 to play back the selected music file.

Further, the control unit 140 controls the playback unit 120 to play back music files, and controls the user interface unit 110 to display an operation menu below the music information of a corresponding music file.

Next, when the playback unit 120 completes the playback of the music file, the control unit 140 controls the playback unit 120 to play back the next music file out of a list of plural music files following the music file that has been played back. The control unit 140 controls the playback unit 120 to keep on playing back music files until a stop request signal is input through the user interface unit 110.

If the transfer request signal for a specific music file is input through the user interface 110 by a user, the control unit 140 controls the transfer unit 130 to send the selected music file to a corresponding storage medium.

FIG. 4 is a view for explaining the functions of an application program according to an exemplary embodiment of the present invention.

For purposes of presentation to a user, the user interface unit 110 displays a list of plural music files read from an HDD or a CD as shown in a window of FIG. 4. Through such a window, the user can select a music file intended to play back or to transfer.

FIG. 4 shows the state that a list of 17 music files is displayed on one window. The user can move the window using a mouse or a scroll bar to check the next list, and can select a desired music file out of the list.

If the user selects the 15^{th} music file to play back out of the list of plural music files, the playback unit 120 plays back the 15^{th} music file. Further, as shown in FIG. 4, the line displaying the music information of the 15^{th} music file is extended to provide an expanded portion, and the expanded portion A displays information related to the 15^{th} music file, i.e., detailed information or lyric information.

Further, like the user interface of a conventional multimedia playback program, the user interface unit 110 can include transfer menus B and B′ enabling a user to select a music file and a storage medium in a separate area. The transfer menus B and B′ can be provided at a certain side of the list of plural music files in the user interface unit 110.

If the user interface unit 110 is provided with the transfer menus B and B′, the user selects a music file out of the list which is intended to transfer, and moves the cursor to the transfer menus B and B′ to select a desired storage medium.

Through the user interface unit 110 provided by the application program 100 according to an exemplary embodiment of the present invention, the user can select a storage medium to which the user is to send a music file by using the storage media selection menu on the list of plural music files without moving the cursor, or can select a storage medium by using a transfer menus B and B′ in the manner as existing.

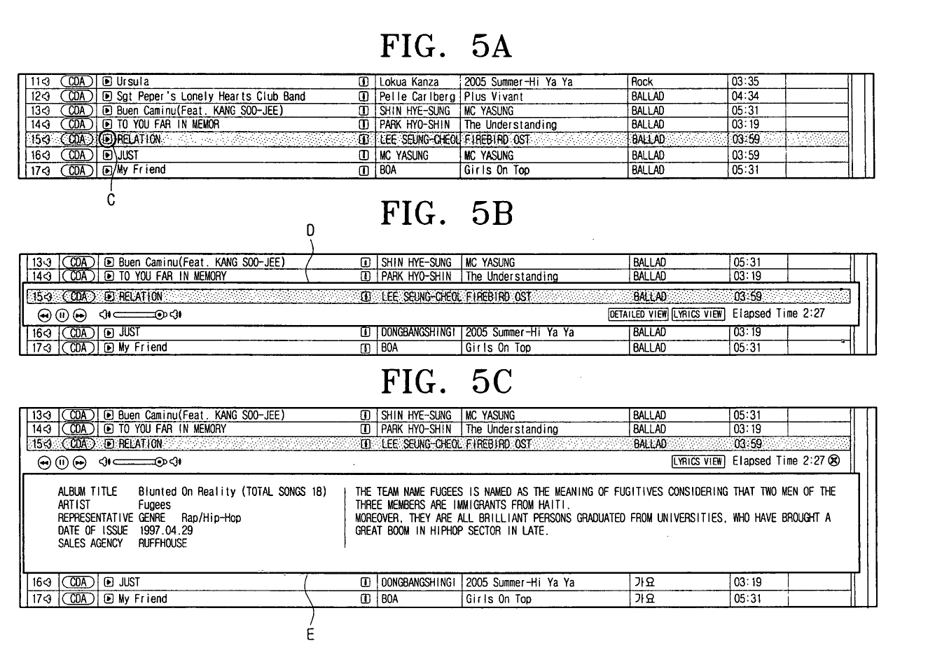

FIGS. 5A to 5C are views for explaining a music file playback method using an application program according to an exemplary embodiment of the present invention.

If the user selects a certain storage medium, i.e., an HDD or a CD, after executing the application program 100 in a user terminal, the control unit 140 reads plural music files stored in the corresponding storage medium.

Next, the user interface unit 110 displays the list of plural music files as shown in FIG. 4, and a user can select a music file out of the list to play back or transfer.

FIGS. 5A to 5C are views for explaining a music file playback method using the application program 100 according to an exemplary embodiment of the present invention, which shows a portion of the list of plural music files as depicted in FIG. 4.

In FIG. 5A, it is assumed that the user plays back the 15^{th} music file out of the list of plural music files. A user clicks on the playback button C in front of the song title of the 15^{th} music file. By doing so, a playback request signal is input into the control unit 140 from the user interface unit 110.

If the control unit 140 receives the playback request signal from the user interface unit 110, it controls the playback unit 120 to play back a music file corresponding to the playback request signal. Further, the control unit 140 controls an operation menu D to be displayed by extending the line displaying the music information of the corresponding music file out of the list displayed by the user interface unit 110.

FIG. 5B shows the operation menu D displayed on the extended portion of the line displaying the music information of the 15^{th} music file selected by the user. As shown in FIG. 5B, the operation menu D has buttons enabling a user to select functions of rewind, fast forward, pause, volume control, detailed view, and lyrics view.

The user can select a function of rewind, fast forward, pause, volume control, detailed view, or lyrics view out of the operation menu D shown in FIG. 5B. If the user clicks on the detailed view button, the control unit 140 controls the user interface unit 110 to further expand the line displaying the music information of the music file to display detailed information of the corresponding music file.

In the state that the detailed information on the 15^{th} music file selected by the user is displayed in FIG. 5C, the area displaying the operation menu of FIG. 5B is further extended to display detailed information E related to the disc.

Next, if a user selects the lyric view on the operation menu D, the control unit 140 controls lyrics information on the 15^{th} music file to be displayed instead of the detailed information E shown in FIG. 5C through the user interface unit 110.

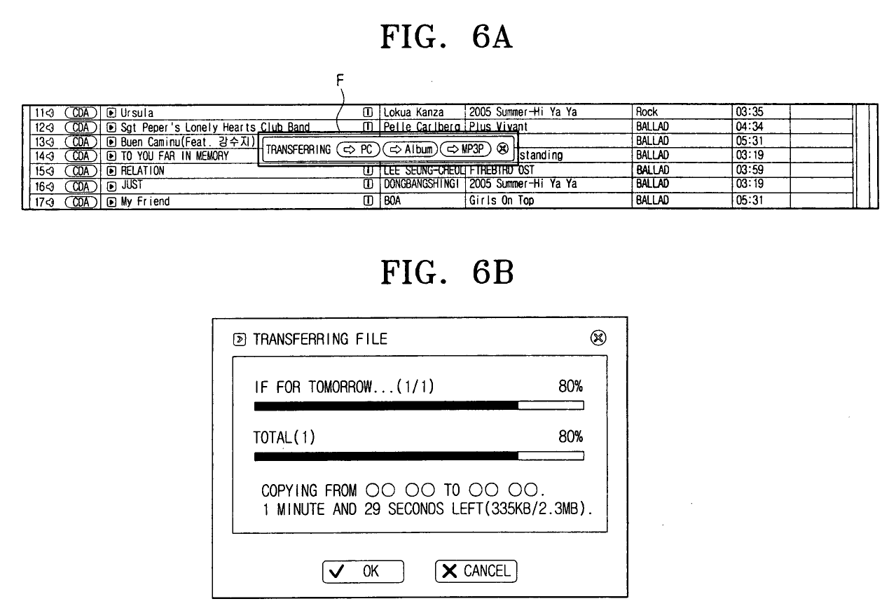

FIGS. 6A to 6B are views for explaining a music file transfer method using an application program according to an exemplary embodiment of the present invention.

In FIG. 6A, it is assumed that the user transfers the 13^{th} music file out of the list of plural music files to a certain storage medium. The user puts the cursor on the line displaying the music information of the 13^{th} music file.

If the cursor is placed on the line displaying the music information, the user interface unit 110 opens a window with the storage medium selection menu F above the player at the point where the cursor is located on the corresponding line. As shown in FIG. 6A, the storage medium selection menu F may include a “PC” button for transfer to a user terminal, an “Album” button for transfer to a specific folder of the user terminal, and an “MP3” button for transfer to an MP3 player.

In FIG. 6B, if the user selects one storage medium to which a music file is transferred through the storage medium selection menu F, a pop-up window is displayed which notifies of the transfer progress status of the 13^{th} music file being transferred to the selected storage medium. Through the pop-up window, the user can check the transfer status of the 13^{th} music file of user's selection to the storage medium.

As explained in FIGS. 6A to 6B, if the cursor is placed on the line displaying the music information of the desired music file on the list of music files, the storage medium selection menu F is displayed at the point where the cursor is located, so the user can individually transfer the music file to a desired storage medium through a simple operation.

As described above, the user terminal and music file management method according to an exemplary embodiment of the present invention have features such that the user can receive a list of music files and information related to a specific music file through one window since detailed information and lyrics information of music files in the list are displayed during the playback of the music files.

Further, since various storage medium selection menus may be displayed at the point where the cursor is located if the cursor is placed on a music file intended to transfer, an exemplary embodiment of the present invention can minimize an unnecessary movement line of the mouse and prevent operation errors caused by moving the cursor across areas.

As aforementioned, the exemplary embodiments of the present invention are shown and described, but the present invention is not limited to the exemplary embodiments described above, and can be implemented with various modifications by those skilled in the art to which the present invention pertains without departing from the scope of the present invention claimed in the appended claims.

What is claimed is:

1. A user terminal installed with an application program for music file playback, the application program comprising:
a user interface unit which displays a list of music files;
a playback unit which plays back a music file selected from the list;
a transfer unit which transfers the music file selected from the list to a storage medium; and
a control unit which controls the playback unit to play back the selected music file and at the same time controls the list to display an operation menu below music information of the music file being played back in the list, if a playback request signal is input through the user interface unit, and controls the transfer unit to transfer the selected music file, if a transfer request signal is input.

2. The user terminal as claimed in claim 1, wherein the music information includes a song title, a singer name, an album title, genre, playback time, and preference.

3. The user terminal as claimed in claim 1, wherein the user interface unit extends a line to expand an area which displays the music information to display the operation menu in the area.

4. The user terminal as claimed in claim 1, wherein the operation menu is provided with buttons enabling a user to select functions comprising rewind, fast forward, volume control, detailed view, and lyrics view.

5. The user terminal as claimed in claim 4, wherein, if at least one of the detailed view and the lyrics view is selected, the user interface unit extends a line to expand an area which displays the music information, and displays at least one of detailed information and lyrics information in the area.

6. The user terminal as claimed in claim 1, wherein the user interface unit displays a playback progress ratio of the playback unit in a bar on a line displaying music information of the selected music file.

7. The user terminal as claimed in claim 1, wherein the storage medium comprises at least one of a specified folder, a Compact Disk (CD), and an MP3 player.

8. The user terminal as claimed in claim 1, wherein, if a cursor is placed on a line displaying music information of the music file, the user interface unit displays a storage medium selection menu for transferring the music file by the transfer unit at a point where the cursor is located.

9. The user terminal as claimed in claim 1, wherein, if the selected music file is completely played back, the control unit controls the playback unit to play a music file from the list which is next to the music file which was played back.

10. A music file management method, comprising:
displaying a list of music files; and
playing back a music file selected by a user, if a playback request signal is input for the music file, and displaying an operation menu below music information of the music file being played back, and transferring the selected music file to a storage medium if a transfer request signal is input.

11. The method as claimed in claim 10, wherein, when the operation menu is displayed, a line displaying music information of the selected music file is extended to form an expanded area, and the operation menu is displayed in the expanded area.

12. The method as claimed in claim 10, wherein the operation menu is provided with buttons for selecting functions comprising rewind, fast forward, volume control, detailed view, and lyrics view.

13. The method as claimed in claim 12, wherein, if the user selects at least one of the detailed view and the lyrics view, a line displaying the music information is extended to expand an area which displays at least one of detailed information or lyrics information in the area.

14. The method as claimed in claim 10, wherein the storage medium comprises at least one of a specified folder, a Compact Disk (CD), and an MP3 player.

15. The method as claimed in claim 10, further comprising playing back another music file which is in the list next to the music file that was previously played back.
